(19) United States
(12) Patent Application Publication
(10) Pub. No.: US 2008/0036179 A1
(43) Pub. Date: Feb. 14, 2008

(54) Systems and methods for providing a towing apparatus having an integral ball

(76) Inventor: John I. Andersen, Idaho Falls, ID (US)

Correspondence Address: KIRTON AND MCCONKIE, 60 EAST SOUTH TEMPLE,, SUITE 1800, SALT LAKE CITY, UT, 84111, US

(21) Appl. No.: 11/800,973

(22) Filed: May 7, 2007

Related U.S. Application Data
(63) Continuation-in-part of application No. 11/358,782, filed on Feb. 21, 2006, now Pat. No. 7,222,510.
Application No. 11/358,782 is a division of application No. 11/159,436, filed on Jun. 20, 2005, now Pat. No. 7,156,412.
Application No. 11/159,436 is a continuation of application No. 10/306,988, filed on Nov. 27, 2002, now Pat. No. 6,908,099.
(60) Provisional application No. 60/798,893, filed on May 8, 2006.

(51) Int. Cl. B60D 1/06; B60D 1/52

(52) U.S. Cl. 280/511

(57) ABSTRACT

Systems and methods for providing a towing apparatus having a component, such as a ball, that is made integral to the towing apparatus through a process of forging, casting or welding to increase the strength of the towing apparatus. Specifically, while spinning the ball component at a high speed, a ball mount shank component is hydraulically forced onto the ball component under a large amount of pressure. The friction generated melts or otherwise integrates the ball and ball mount shank components together to create a single, integral unit. In at least some implementations, the towing apparatus includes a monolithic ball mount for towing, wherein the ball mount includes a coupling mechanism at a first end to couple the ball mount to a tow vehicle and a ball on a second end to couple to a trailer or towed vehicle. Implementations further include an aesthetically designed and engineered section between the coupling mechanism and the ball.

### RELATED APPLICATIONS

This application claims priority to U.S. Provisional Patent Application Ser. No. 60/798,893 filed May 8, 2006, entitled SYSTEMS AND METHODS FOR PROVIDING A TOWING APPARATUS HAVING AN INTEGRAL BALL.

### BACKGROUND OF THE INVENTION

1. Field of the Invention

The present invention relates to providing a towing apparatus. In particular, the present invention relates to systems and methods for providing a towing apparatus having a first component that is made integral to a second component of the towing apparatus through a process of forging, casting or welding to increase the strength of the towing apparatus.

1. Background and Related Art

Techniques are currently available to manufacture and use ball mounts that are configured to selectively couple a tow vehicle to a trailer. The ball mounts typically include an elongate body having a first end mounted or welded to the frame of the towing vehicle and a second end coupled to a tow ball through the use of a stud, lock washer and nut assembly. Should the nut come loose or fall off while in tow, damage can result to the tow vehicle, trailer, and/or others. Securing the tow ball can require a large wrench that provides the necessary torque to prevent the nut from coming loose during use of the ball mount.

The trailer typically includes a receiving arm having a cavity configured to match the tow ball. The portion of the receiving arm about the tow ball is secured to enable the vehicle to tow the trailer. When the user desires to decouple the trailer from the vehicle, the portion of the receiving arm about the tow ball can be selectively unsecured from and lifted off of the tow ball, thereby decoupling the vehicle from the trailer.

More recently, ball mount receivers have been mounted to the frame of the towing vehicle to selectively remove the ball mount from the vehicle. The ball mount receiver receives a portion of the ball mount, and secures the ball mount to the ball mount receiver by aligning holes in the ball mount receiver and the ball mount and placing a secured pin through the holes. When desired, the user may selectively un-secure and pull out the pin, and remove the ball mount from the ball mount receiver.

Thus, while techniques currently exist that are used to manufacture or otherwise provide a ball mount for use in towing, challenges still exist with such techniques. Accordingly, it would be an improvement in the art of manufacturing and/or providing ball mounts to augment or even replace current techniques with other techniques.

### SUMMARY OF THE INVENTION

The present invention relates to providing a towing apparatus. In particular, the present invention relates to systems and methods for providing a towing apparatus having a first component that is made integral to a second component of the towing apparatus through a process of forging, casting or welding to increase the strength of the towing apparatus.

Implementations of the present invention embrace a towing apparatus that is configured for use with a vehicle for towing, wherein a ball mount, tow bar, drop bar or draw bar includes a component, such as a ball or other component, that is integral to the ball mount, tow bar, drop bar or draw bar to increase the strength of the ball mount, tow bar, drop bar or draw bar. In at least some implementations, the towing apparatus includes a monolithic ball mount for towing, wherein the ball mount includes a coupling mechanism at a first end to couple the ball mount to a tow vehicle and a ball on a second end to couple to a trailer or towed vehicle. Implementations further include an aesthetically designed and engineered section between the coupling mechanism and the ball.

In at least some implementations, the component is made integral to the ball mount shank through a process of forging, casting or welding. Examples of welding include friction welding, fusion welding, and other welding processes. In an implementation that includes friction welding, while spinning a ball component at a high speed, the ball mount shank component is hydraulically forced onto the ball component under a large amount of pressure (e.g., 20 tons of pressure or another amount of pressure). The friction generated melts or otherwise integrates the ball component and ball mount shank component together to create a single, integral unit. Accordingly, at least some implementations of the present invention embrace use of dissimilar metals, each a component, which are friction welded to form a ball mount with integral components.

At least some implementations of the present invention embrace a monolithic design that is provided by forging the component in a single piece in its entirety. Alternatively, the square tube is welded onto a monolithic piece that goes from the tube, through the transition, and up to and including the ball. Accordingly, in some implementations the combination transition and ball section is a monolithic piece through forging. The combination transition and ball section is then welded (e.g., friction welded, fusion welded, or otherwise welded using another process) to the component or section that is configured to be received by the ball mount receiver of the tow vehicle.

These and other features and advantages of the present invention will be set forth or will become more fully apparent in the description that follows and in the appended claims. The features and advantages may be realized and obtained by means of the instruments and combinations particularly pointed out in the appended claims. Furthermore, the features and advantages of the invention may be learned by the practice of the invention or will be obvious from the description, as set forth hereinafter.

### BRIEF DESCRIPTION OF THE DRAWINGS

In order that the manner in which the above recited and other features and advantages of the present invention are obtained, a more particular description of the invention will be rendered by reference to specific embodiments thereof, which are illustrated in the appended drawings. Understanding that the drawings depict only typical embodiments of the present invention and are not, therefore, to be considered as limiting the scope of the invention, the present invention will be described and explained with additional specificity and detail through the use of the accompanying drawings in which:

FIG. 1 illustrates a perspective view of a representative embodiment in accordance with the present invention;

FIG. 2 illustrates a representative component of the embodiment of FIG. 1;

FIG. 3 illustrates a side view of the embodiment of FIG. 1;

FIG. 4 illustrates a perspective view of another representative embodiment in accordance with the present invention;

FIG. 5 illustrates a representative component of the embodiment of FIG. 4;

FIG. 6 illustrates a side view of the embodiment of FIG. 4;

FIG. 7 illustrates a perspective view of another representative embodiment in accordance with the present invention;

FIG. 8 illustrates a representative component of the embodiment of FIG. 7;

FIG. 9 illustrates a side view of the embodiment of FIG. 7;

FIG. 10 illustrates a perspective view of another representative embodiment in accordance with the present invention;

FIG. 11 illustrates a representative component of the embodiment of FIG. 10;

FIG. 12 illustrates a perspective view of a representative embodiment in accordance with the present invention;

FIG. 13 illustrates a side view of the embodiment of FIG. 12;

FIG. 14 illustrates a back perspective view of the embodiment of FIG. 12;

FIG. 15 illustrates a front view of the embodiment of FIG. 12;

FIG. 16 illustrates a perspective view of another representative embodiment in accordance with the present invention, wherein a cap is selectively coupled;

FIG. 17 illustrates a perspective view of the embodiment of FIG. 16 with a cap coupled thereto;

FIG. 18 illustrates a perspective view of a representative embodiment in accordance with the present invention, wherein a cap is selectively coupled;

FIG. 19 illustrates a perspective view of a representative embodiment in accordance with the present invention, wherein a cap is selectively coupled; and

FIG. 20 illustrates a perspective view of the embodiment of FIG. 19 with a cap coupled thereto.

### DETAILED DESCRIPTION OF THE INVENTION

The present invention relates to providing a towing apparatus. In particular, the present invention relates to systems and methods for providing a towing apparatus, such as a ball mount, tow bar, drop bar or draw bar, having a first component that is made integral to a second component the towing apparatus through a process of forging, casting or welding to increase the strength of the towing apparatus.

Embodiments of the present invention embrace a towing apparatus that is configured for use with a vehicle for towing, wherein the ball mount includes components that are made integral to the ball mount to increase strength of the ball mount. In at least some embodiments, the towing apparatus includes a monolithic ball mount for towing, wherein the ball mount includes a coupling mechanism at a first end to couple the ball mount to the receiver of a tow vehicle and a ball on a second end to couple to a trailer or towed vehicle. Embodiments further include an aesthetically designed and engineered section between the coupling mechanism and the ball.

In at least one embodiment, the ball is made integral to the ball mount transition section/component through a process of forging, casting or welding. Examples of welding include friction welding, fusion welding and other welding processes. In an embodiment that embraces friction welding, while spinning the ball at a high speed, the ball mount shank, for example, is hydraulically forced onto the ball under a large amount of pressure (e.g., 20 tons of pressure or other amount of pressure). The friction generated integrates at least a portion of the ball and ball mount shank together to create a single, integral unit. Accordingly, at least some implementations of the present invention embrace use of dissimilar metals that are friction welded to form a ball mount with an integral ball.

In some embodiments, the towing apparatus includes an integral, monolithic ball that is used for towing a trailer by a tow vehicle, such as a pickup truck, car or SUV. In one embodiment, the towing apparatus comprises a tow bar configuration of either a rise or drop configuration. One end is designed to connect to the receiver tube commonly found at or near the rear end of a towing vehicle. Examples of such receivers are, for example, a 1½ inch or 2 inch square shank with a ⅝ inch diameter hole drilled or punched in it to receive an attachment pin to retain a ball mount within the receiver of the towing vehicle. Those skilled in the art will appreciate that embodiments of the present invention embrace a variety of different sized and/or configured towing apparatuses and/or receivers. Monolithically attached to the rear end of the 2 inch shank, for example, is a smooth flowing, aesthetically appealing transition section that provides the rise or drop receiver section with a ball mount ball integrally connected to its rearward and upper end, either by welding, forging or casting. This design eliminates the threaded stud, lock washer, and nut commonly used to attach a ball onto a ball mount and commonly becomes loose, due to the jerking motion of the tow and towed trailer or vehicle attached to it.

In some embodiments, an integral ball mount, tow bar, drop bar or draw bar is provided through the use of a casting process. For example, a wax copy of the ball mount, tow bar, drop bar or draw bar is created and then coated in a ceramic slurry. The ceramic slurry forms a shell about the wax copy. The wax is then melted away and forms the ceramic slurry into a shell mold. The metal is poured into the ceramic shell mold and allowed to solidify. The shell mold is removed as the metal is cooled to provide the metallic ball mount, tow bar, drop bar or draw bar. Further, the ball mount, tow bar, drop bar or draw bar is integral to increase the strength of the towing apparatus (e.g., ball mount, tow bar, drop bar or draw bar).

Embodiments of the present invention embrace the utilization of a variety of materials, including aluminum, steel, stainless steel, and/or any other metal and/or metal alloy. Embodiments of the present invention further embrace the utilization of dissimilar materials within adjacent components, wherein the dissimilar materials are made integral through a process of welding, forging or casting.

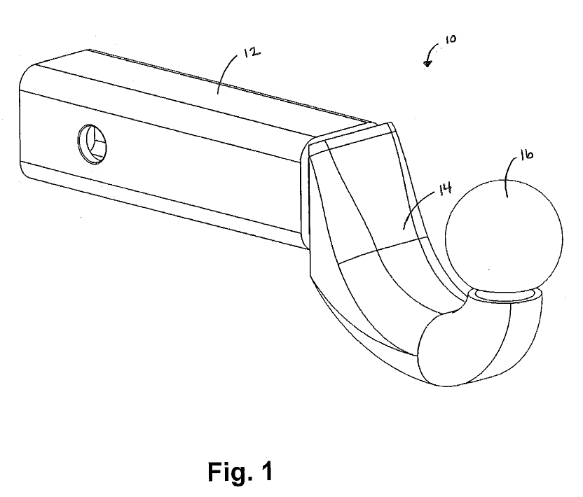

With reference now to FIGS. 1-3, a representative embodiment is illustrated, wherein the embodiment includes a plurality of components that have been made integral to the towing apparatus. FIG. 1 illustrates the embodiment in a perspective view of the embodiment. In FIG. 1, ball mount 10 comprises a shank component 12, a transition component 14 and a ball component 16. Components 12-16 are monolithically coupled through a welding, forging and/or casting process. Accordingly, ball mount 10 comprises increased strength for towing. In further embodiments, two or more of the components are integrally coupled through a friction weld process or a fusion weld process.

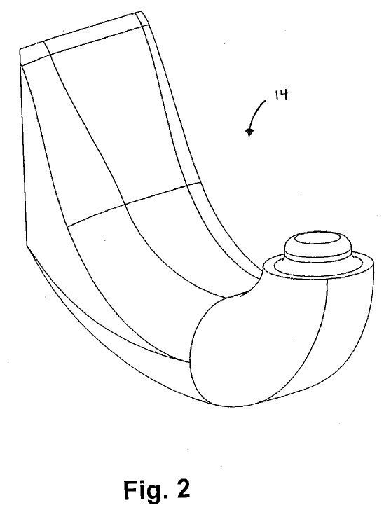

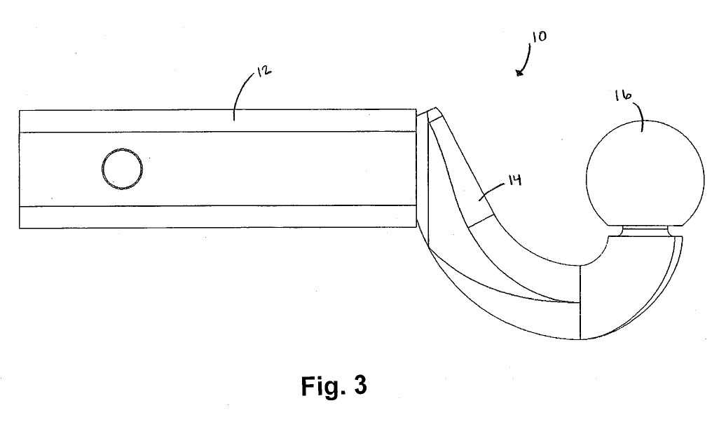

FIG. 2 illustrates transition component 14. Another representative component is ball, illustrated as ball component 16 in FIG. 1. Accordingly, in accordance with an embodiment of the present invention, transition component 14 of FIG. 2 is coupled to ball component 16 (see FIG. 1 and FIG. 3) by a friction weld process to make the two components integral. Furthermore transition component 14 of FIG. 2 may be coupled to a receiver component (illustrated as shank component 12) through a friction weld process, wherein the receiver component is configured to selectively couple to a ball mount receiver of a tow vehicle. FIG. 3 illustrates a side view of the representative embodiment.

Those skilled in the art will appreciate that the components of the towing apparatus may comprise similar or dissimilar materials, and are made integral by utilization of a coupling process, such as a friction weld or fusion weld process.

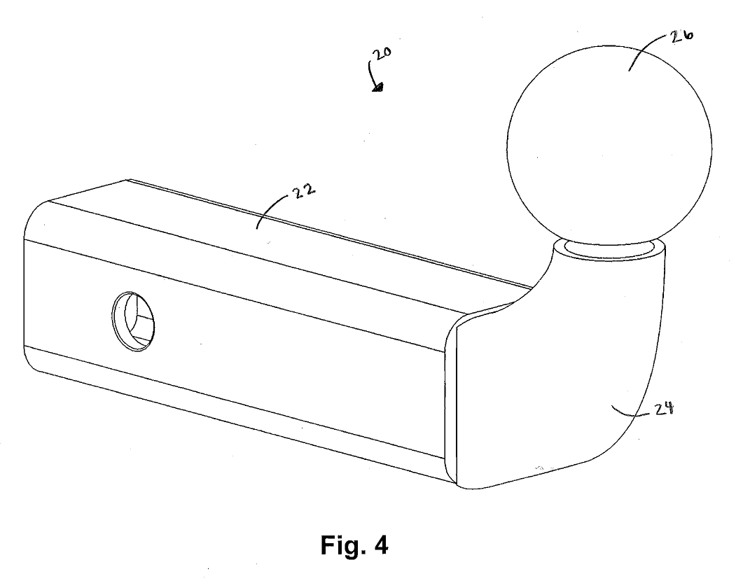

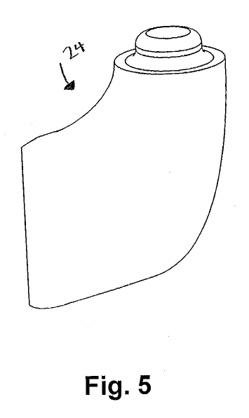

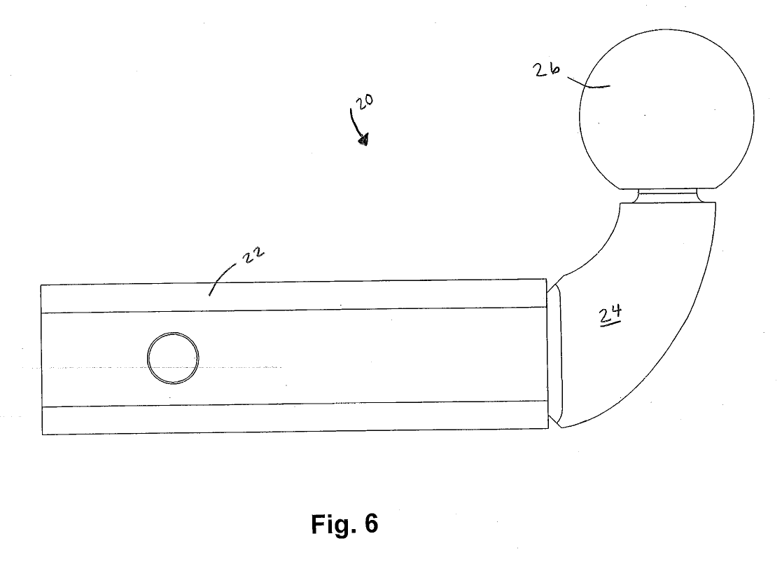

With reference now to FIGS. 4-6, another representative embodiment is illustrated, wherein the illustrated embodiment is ball mount 20 that includes a plurality of components (e.g., shank component 22, transition component 24, and ball component 26) that have been made integral to the towing apparatus. FIG. 4 illustrates the representative embodiment in a perspective view. FIG. 5 illustrates a representative component as transition component 24. As provided above, another representative component is a ball, illustrated in FIGS. 4 and 6 as ball component 26. Accordingly, in accordance with an embodiment of the present invention, the transition component 24 of FIG. 5 is integrally coupled to a ball component 26 (see FIGS. 4 and 6) by a friction weld process to make the two components integral. Similarly, transition component 24 of FIG. 5 is integrally coupled to a shank component 22 (see FIGS. 4 and 6) by a friction weld or a fusion weld process to make the two components integral. FIG. 6 illustrates a side view of the representative embodiment.

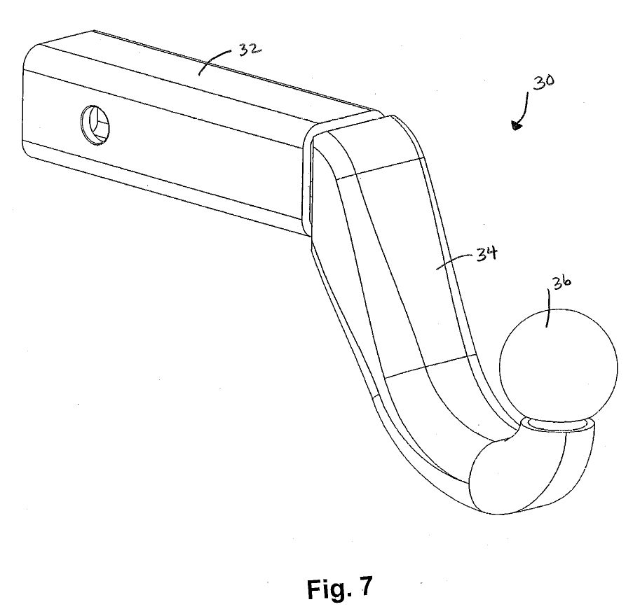

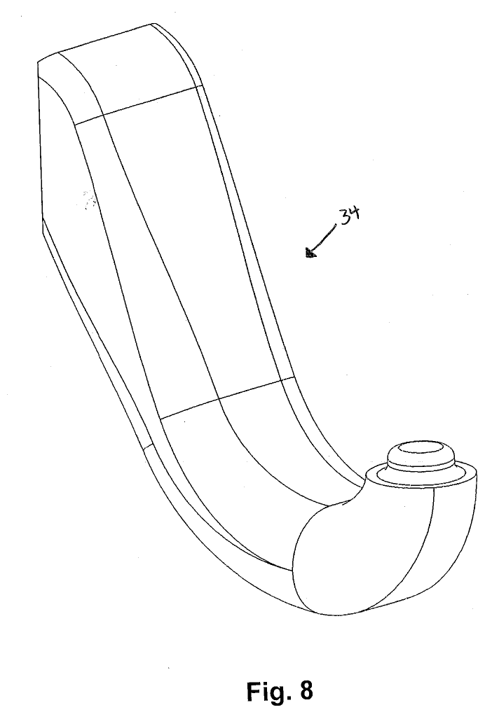

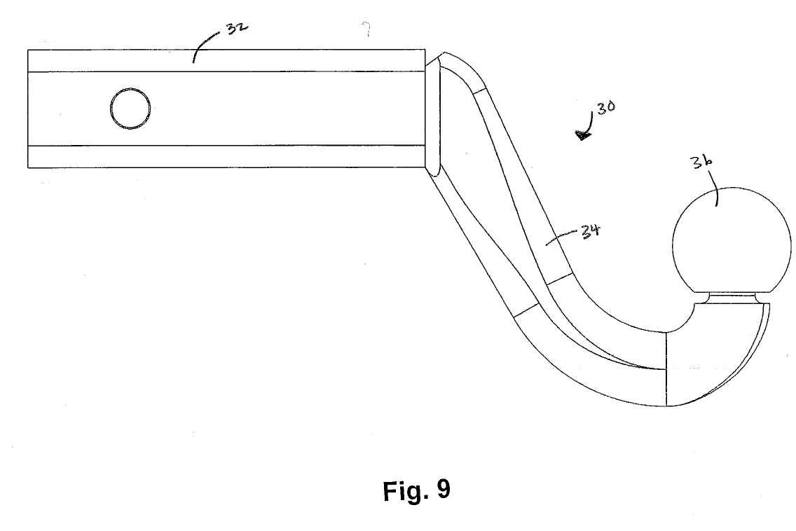

With reference now to FIGS. 7-9, another representative embodiment is illustrated as ball mount 30, which includes a plurality of components (e.g., shank component 32, transition component 34, and ball component 36) that have been made integral to the towing apparatus. In accordance with some embodiments of the present invention, the components can comprise separate materials, including dissimilar materials, that may be made integral through the methods and processed provided herein. FIG. 7 illustrates the representative embodiment (ball mount 30) in a perspective view. FIG. 8 illustrates a representative transition component 34. Another representative component is a ball, which is illustrated in FIGS. 7 and 9 as ball component 36. Accordingly, in accordance with an embodiment of the present invention, the transition component 34 of FIG. 8 is integrally coupled to a ball component 36 (see FIGS. 7 and 9) by a friction weld or a fusion weld process to make the two components integral. Furthermore the transition component 34 of FIG. 8 may be coupled to another component, such as a receiver or shank component (e.g., shank component 32), through a friction weld or fusion weld process, wherein the receiver component (e.g., shank component 32) is configured to selectively couple to a ball mount receiver of a tow vehicle. FIG. 9 illustrates a side view of the representative embodiment, illustrated as ball mount 30.

The components of FIGS. 2, 5 and 8 are transition components that illustrate that embodiments of the present invention embrace a variety of sizes and shapes for utilization in a towing apparatus. Those skilled in the art will appreciate that embodiments of the present invention embrace any other size and/or configuration.

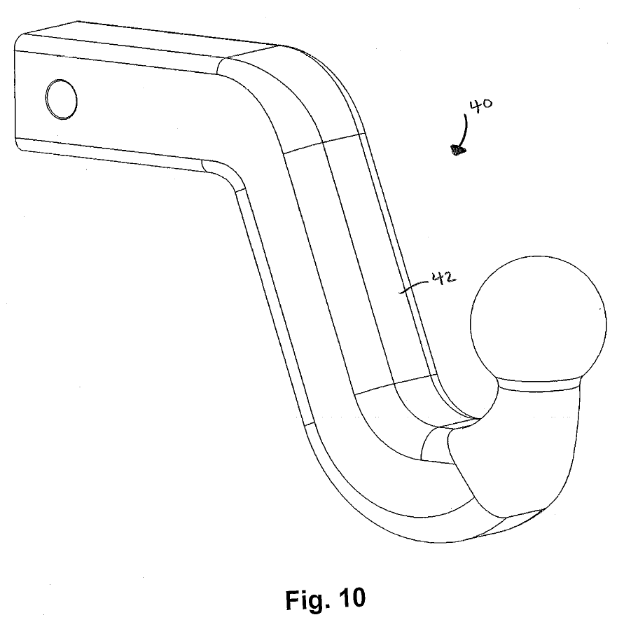

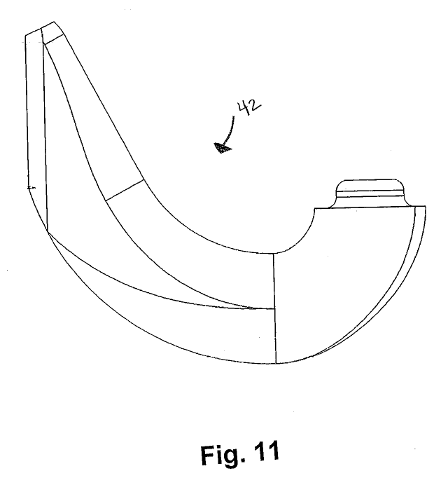

FIG. 10 illustrates a perspective view of another representative embodiment, illustrated as ball mount 40, in accordance with the present invention, wherein FIG. 11 illustrates a representative transition component 42 of ball mount 40.

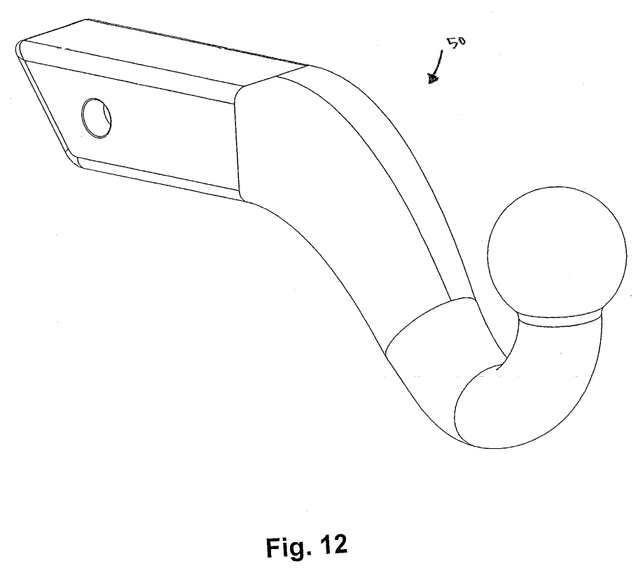

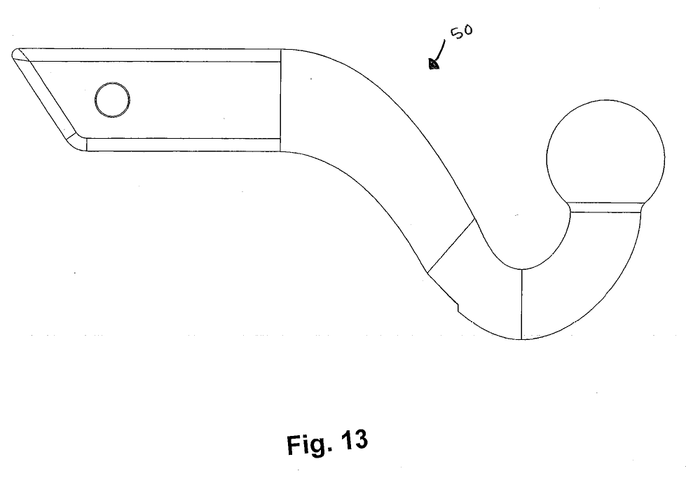

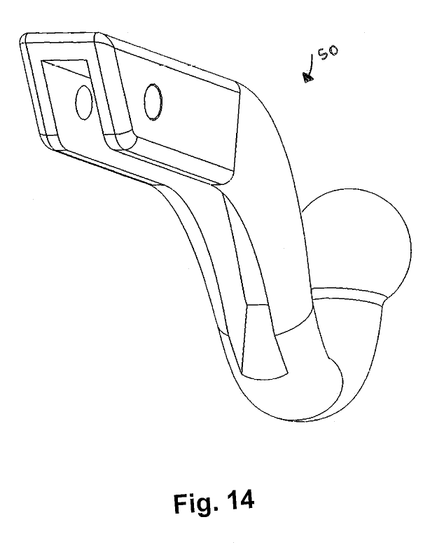

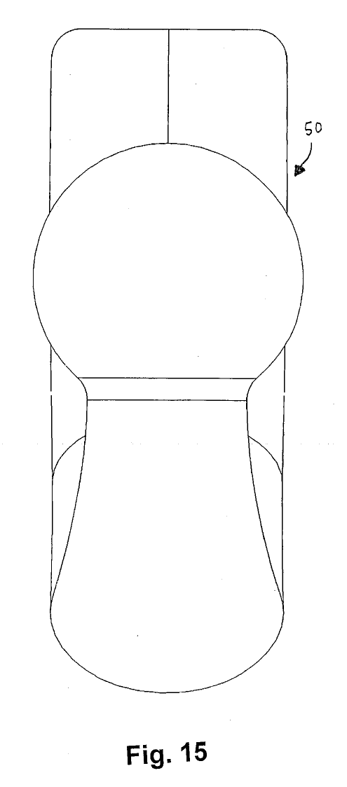

FIGS. 12-15 illustrate another representative embodiment, illustrated as ball mount 50, wherein FIG. 12 illustrates a perspective view, FIG. 13 illustrates a side view, FIG. 14 illustrates another perspective view, and FIG. 15 illustrates a front view of the embodiment. Ball mount 50 comprises one or more components thereof that are made integral through a forging, casting and/or welding process.

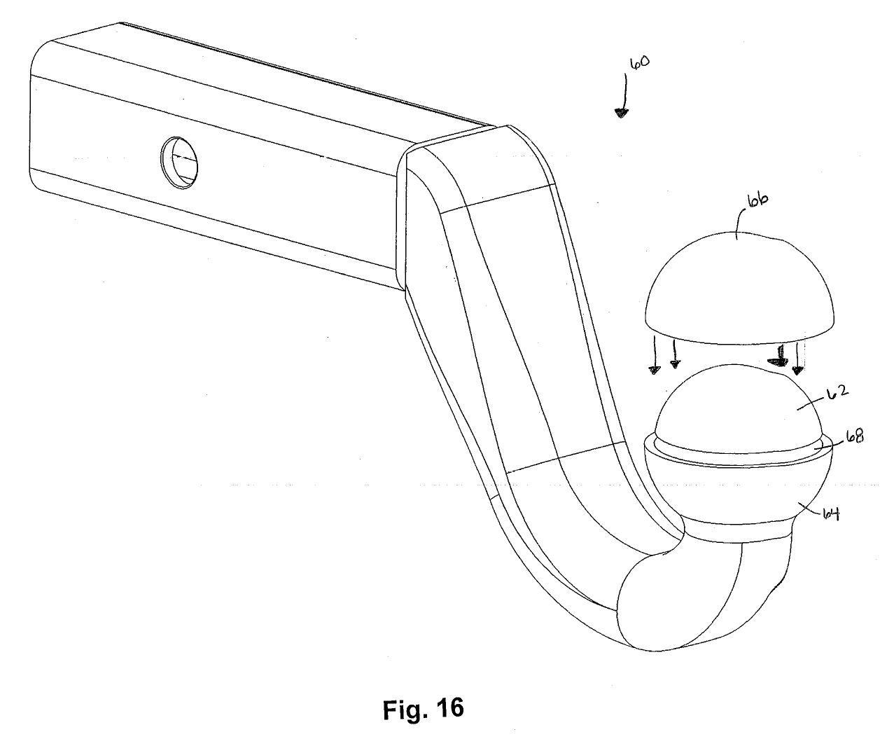

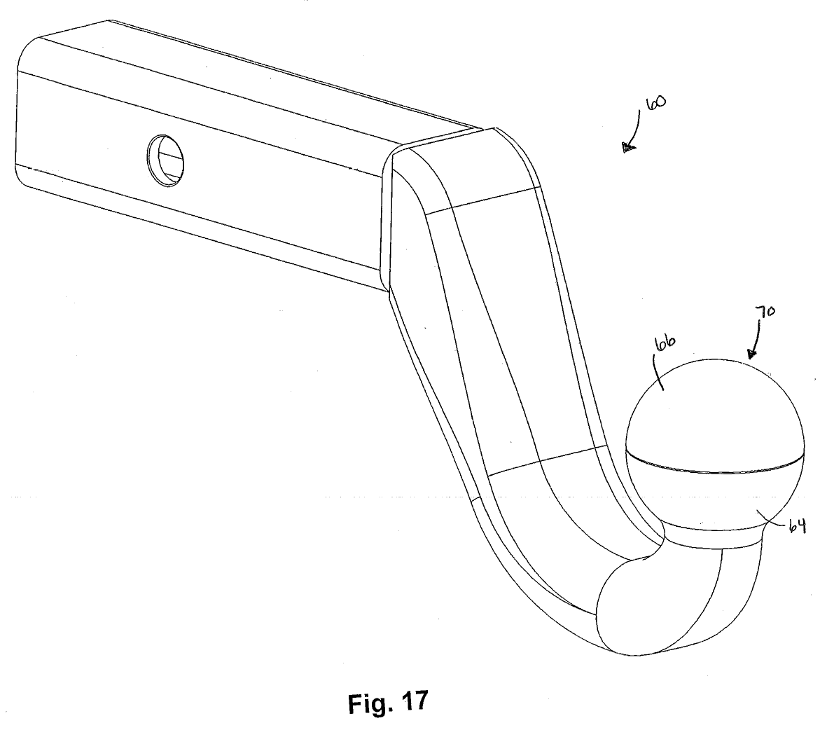

At least some embodiments of the present invention further comprise a cap. For example, with reference now to FIGS. 16-17 a representative embodiment is illustrated as ball mount 60, wherein a cap 66 is being coupled to a top ball portion 62. As illustrated in FIG. 16, top ball portion 62 comprises a perimeter that is smaller than the perimeter of bottom ball portion 64. Further, a channel 68 is provided that retains cap 66 coupled to top ball portion 62. As illustrated in FIG. 17, once cap 66 is coupled to top ball portion 62, ball component 70 is spherical on the outer perimeter.

In at least some embodiments, the cap comprises a polymer, an elastomer, a nylon, an alloy or another material or combination of materials. For example in one embodiment, the cap comprises a nylon that includes graphite to eliminate or prevent ultraviolet radiation and to add lubricity to the nylon. The cap is configured to be associated with a hemisphere of the ball component. When the cap is coupled to at least a portion of the ball component, such as the top hemisphere of the ball component, a greaseless or self-lubricating ball to facilitate use of ball component with a corresponding trailer ball mount receiver is provided. The use of the cap eliminates and/or reduces the need for grease. In one embodiment, the cap lasts a lifetime for a user.

In some embodiments, the cap comprises a metallic alloy. In particular, in one embodiment, the metallic alloy is provided on a surface of the ball component. By way of example, in one embodiment the metallic alloy cap is provided through a heat-treatment process. In another embodiment, the metallic alloy cap is provided through a magnetic pulse that crushes the profile into position. In further embodiments, the metallic alloy cap is corrosion resistant, abrasion resistant, and/or gall resistant.

While the illustrated embodiment provides a cap that covers a hemisphere of a ball component, those skilled in the art will appreciate that embodiments further embrace caps that cover more than a hemisphere or less than a hemisphere. In at least one embodiment, a cap that comprises a polymer, an elastomer, a nylon, an alloy or another material or combination of materials covers all or most of a ball portion (sphere), down to a neck portion, of a ball mount component having a ball portion/component coupled to a neck portion/component.

In one embodiment, the cap is snapped onto the ball component. In another embodiment, the cap is injection molded onto at least a portion of a ball/sphere. In a further embodiment, the material is injected at approximately 500° and then the cap cools and typically shrinks. In one embodiment, the ball/sphere is preheated. In another embodiment, the material (e.g. nylon) is soaked in water or in another aqueous solution. For example, the nylon is soaked in water for 24 hours at 140° to hydrate the nylon. The nylon absorbs water and causes the nylon to have a tougher and more durable characteristic.

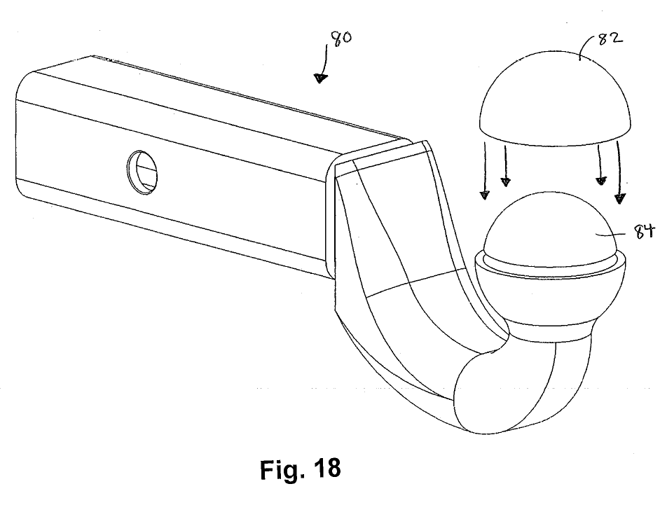

FIG. 18 illustrates a perspective view of a representative embodiment, illustrated as ball mount 80, wherein cap 82 is being coupled to ball component 84.

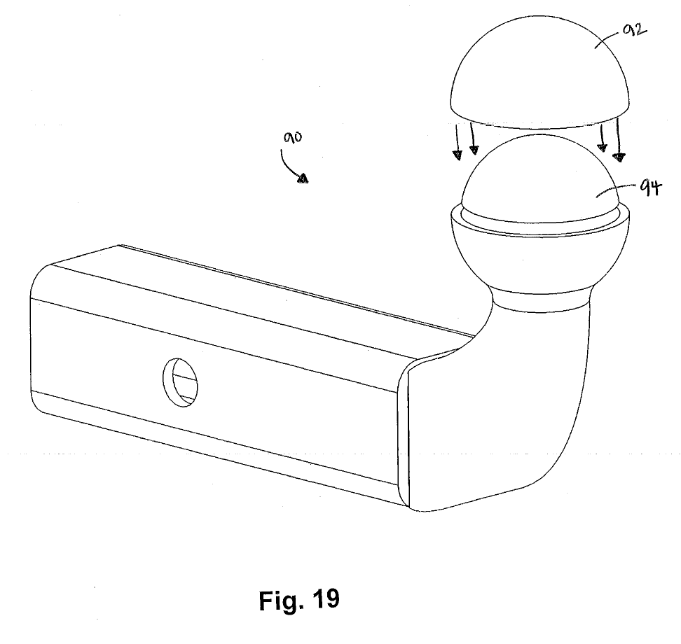

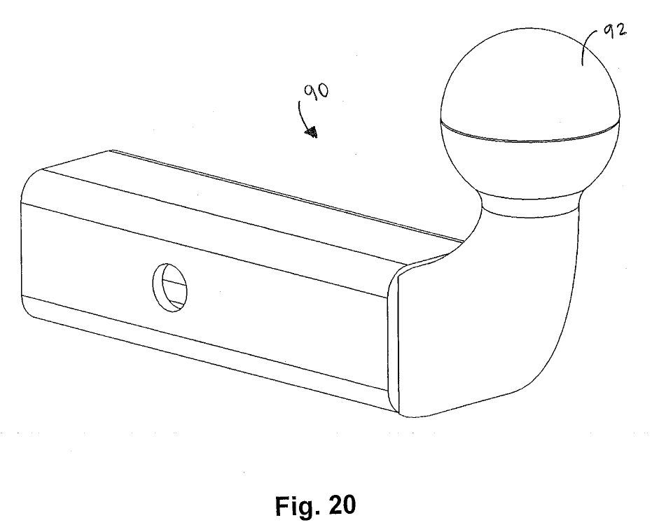

FIG. 19 illustrates a perspective view of a representative embodiment, illustrated as ball mount 90, wherein cap 92 is being coupled to ball component 94. FIG. 20 illustrates a perspective view of ball mount 90 with cap 92.

In some embodiments, a portion of the towing apparatus comprises a carbide surface. In particular, in one embodiment, the carbide surface is brazed on a surface of the ball component.

In some embodiments, a portion of the towing apparatus comprises a metallic alloy cap surface. In particular, in one embodiment, the metallic alloy is provided on a surface of the ball component. By way of example, in one embodiment the metallic alloy cap is provided through a heat-treatment process. In another embodiment, the metallic alloy cap is provided through a magnetic pulse that crushes the profile into position. In further embodiments, the metallic alloy cap is corrosion resistant, abrasion resistant, and/or gall resistant.

Embodiments of the present invention further embrace an abrasion resistant metal cap and/or surface that is created using a heat treating process.

Embodiments of the present invention embrace the fabrication of a towing apparatus that comprises one or more steel components that are welded together. In one embodiment, a transition section is forged. In another embodiment, a component, such as a transition section, is cut out.

Thus, as discussed herein, the embodiments of the present invention embrace a towing apparatus. In particular, the present invention relates to systems and methods for providing a towing apparatus having a ball that is made integral to the towing apparatus through a process of forging, casting or welding to increase the strength of the towing apparatus.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

What is claimed is:

1. A towing apparatus comprising:
a first component of a ball mount; and
a second component of the ball mount, wherein the first and second components are integrally coupled by at least one of:
(i) a forging process;
(ii) a casting process; and
(iii) a welding process.

2. A towing apparatus as recited in claim 1, wherein the first and second components are integrally coupled by the welding process, and wherein the welding process comprises one of (i) a friction weld process and (ii) a fusion weld process.

3. A towing apparatus as recited in claim 1, wherein the second component is a ball component.

4. A towing apparatus as recited in claim 1, wherein the tow ball comprises a cap that is selectively coupled to the tow ball.

5. A towing apparatus as recited in claim 4, wherein the tow ball includes a metallic alloy surface.

6. A method for providing a towing apparatus, comprising:
providing a first component of a ball mount;
providing a second component of the ball mount; and
coupling the first component to the second component through at least one of:
(i) a friction weld process; and
(ii) a fusion weld process.

7. A method as recited in claim 6, wherein the second component is a ball component.

8. A method as recited in claim 6, further comprising coupling a a cap to at least a portion of the ball component.

9. A method as recited in claim 8, wherein the coupling of the cap to the ball component provides a spherical outer perimeter.

10. A method as recited in claim 9, wherein the cap comprises a polymer material.

11. A method as recited in claim 9, wherein the cap comprises a nylon material.

12. A method as recited in claim 6, wherein the ball component includes a metallic alloy surface.

13. A monolithic ball mount for towing, comprising:
a connector on a first end of a ball mount that is configured to be inserted into a receiver of a towing vehicle;
a ball on a second end of the ball mount that is configured to couple to a trailer coupler; and
a transition component integrally coupled to the first end and integrally coupled to the ball.

14. A monolithic ball mount as recited in claim 13, wherein the ball comprises a cap that when coupled to the ball creates a spherical outer perimeter.

15. A monolithic ball mount as recited in claim 14, wherein the cap comprises at least one of:
(i) a nylon material;
(ii) a polymer material; and
(iii) an alloy material.

16. A monolithic ball mount as recited in claim 13, wherein the ball includes a metallic alloy surface.

17. A method for providing a ball mount for towing, the method comprising:
forging a transition component and a ball component into a single, monolithic ball mount; and
welding a coupling component onto the monolithic ball mount using one of:
(i) a friction welding process; and
(ii) a fusion welding process.

18. A method as recited in claim 17, wherein the ball comprises a cap that when coupled to the ball creates a spherical outer perimeter.

19. A method as recited in claim 18, wherein the cap comprises at least one of:
(i) a nylon material;
(ii) a polymer material; and
(iii) an alloy material.

20. A method as recited in claim 17, wherein the ball includes a metallic alloy surface.
